(19) United States
(12) Patent Application Publication
(10) Pub. No.: US 2023/0079963 A1
(43) Pub. Date: Mar. 16, 2023

(54) DATA TRANSMISSION APPARATUS AND DATA TRANSMISSION METHOD CAPABLE OF SAVING USER TIME AND EFFORT

(71) Applicant: KYOCERA Document Solutions Inc., Osaka (JP)

(72) Inventor: Masami Shibahara, Osaka (JP)

(21) Appl. No.: 17/932,046

(22) Filed: Sep. 14, 2022

(30) Foreign Application Priority Data
Sep. 15, 2021 (JP) 2021-149891

(51) Int. Cl. H04N 1/00; G06F 3/12

(52) U.S. Cl. CPC H04N 1/00437; G06F 3/1202

(57) ABSTRACT

A data transmission apparatus includes a reception processing portion and a transmission processing portion. When an instruction to print data is input, the reception processing portion receives a selection operation to select a destination of the data from a printing apparatus that can print the data or a storage that can store the data. The transmission processing portion executes a first transmission process of sending a print job including the data to the printing apparatus when the printing apparatus is selected by the selection operation, and executes a second transmission process of sending the data to the storage using storage location information associated in advance with the storage when the storage is selected by the selection operation.

### INCORPORATION BY REFERENCE

This application is based upon and claims the benefit of priority from the corresponding Japanese Patent Application No. 2021-149891 filed on Sep. 15, 2021, the entire contents of which are incorporated herein by reference.

### BACKGROUND

The present disclosure relates to a data transmission apparatus and a data transmission method.

Upon receiving an input of an instruction to print data, an information processing apparatus such as a personal computer displays a print setting screen used to set conditions for printing the data is displayed in a display portion. In addition, a printing system is known to be able to set an output mode of the data to either “print” or “email” on the print setting screen.

### SUMMARY

A data transmission apparatus according to an aspect of the present disclosure includes a reception processing portion and a transmission processing portion. When an instruction to print data is input, the reception processing portion receives a selection operation to select a destination of the data from a printing apparatus that can print the data or a storage that can store the data. The transmission processing portion executes a first transmission process of sending a print job including the data to the printing apparatus when the printing apparatus is selected by the selection operation, and executes a second transmission process of sending the data to the storage using storage location information associated in advance with the storage when the storage is selected by the selection operation.

A data transmission method according to another aspect of the present disclosure includes a reception step of receiving, when an instruction to print data is input, a selection operation to select a destination of the data from a printing apparatus that can print the data or a storage that can store the data is received; and a transmission step of executing a first transmission process of sending a print job including the data to the printing apparatus when the printing apparatus is selected by the selection operation, and of executing a second transmission process of sending the data to the storage using storage location information associated in advance with the storage when the storage is selected by the selection operation.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram showing a configuration of an information processing system including a second information processing apparatus according to an embodiment of the present disclosure.

FIG. 2 is a block diagram showing a configuration of the second information processing apparatus according to the embodiment of the present disclosure.

FIG. 3 shows an example of a selection screen displayed in the second information processing apparatus according to the embodiment of the present disclosure.

FIG. 4 shows an example of the selection screen displayed in the second information processing apparatus according to the embodiment of the present disclosure.

FIG. 5 is a flowchart showing an example of a data transmission process executed by the second information processing apparatus according to the embodiment of the present disclosure.

### DETAILED DESCRIPTION

The following describes an embodiment of the present disclosure with reference to the accompanying drawings. It should be noted that the following embodiment is an example of a specific embodiment of the present disclosure and should not limit the technical scope of the present disclosure.

### Information Processing System 100

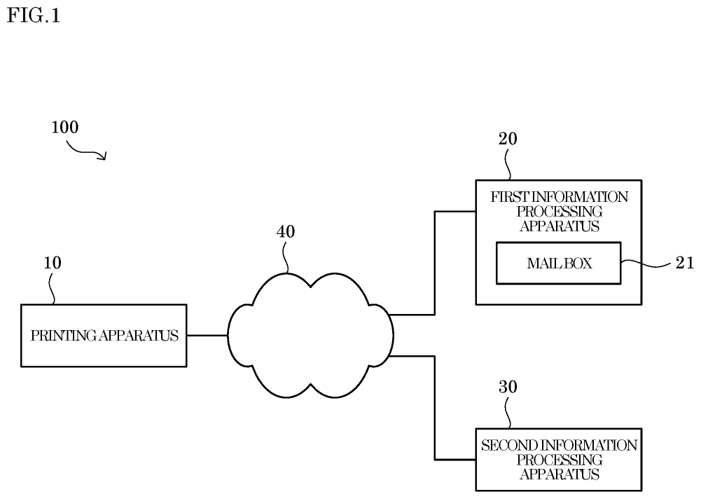

First, an information processing system 100 including a second information processing apparatus 30 according to the embodiment of the present disclosure will be described with reference to FIG. 1.

As shown in FIG. 1, the information processing system 100 includes a printing apparatus 10, a first information processing apparatus 20, and the second information processing apparatus 30.

In the information processing system 100, the printing apparatus 10 and the second information processing apparatus 30 are connected to be able to communicate with each other through a communication network 40 (see FIG. 1). For example, the communication network 40 is the Internet or a LAN (local area network). In addition, in the information processing system 100, the first information processing apparatus 20 and the second information processing apparatus 30 are connected to be able to communicate with each other through the communication network 40.

The printing apparatus 10 is a multifunction peripheral with multiple functions such as a scan function of reading images from document sheets, a print function of forming images based on image data, a facsimile function, and a copy function. The printing apparatus 10 may be a printer, a facsimile apparatus, a copier, or the like.

The first information processing apparatus 20 is an email server that sends and receives emails. As shown in FIG. 1, the first information processing apparatus 20 includes at least one mailbox 21. The mailbox 21 stores emails sent to an email address corresponding to the mailbox 21.

### Second Information Processing Apparatus 30

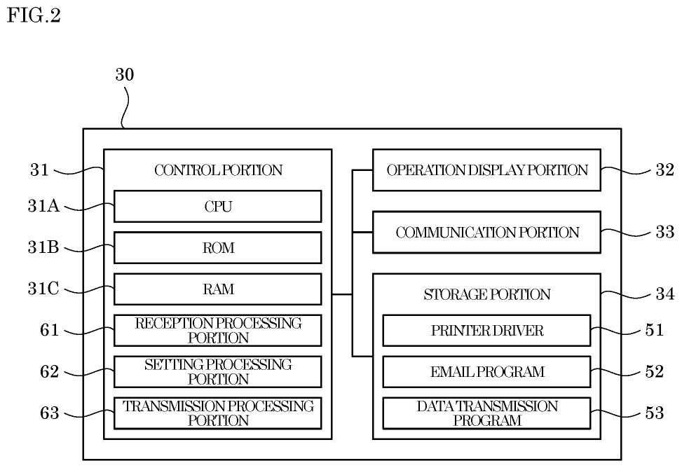

Next, the second information processing apparatus 30 according to the embodiment of the present disclosure will be described with reference to FIGS. 2 to 4.

The second information processing apparatus 30 is a personal computer used by a user of the information processing system 100. The second information processing apparatus 30 is an example of a data transmission apparatus of the present disclosure. The data transmission apparatus of the present disclosure may be a notebook computer, a smartphone, a tablet computer, or the like.

As shown in FIG. 2, the second information processing apparatus 30 includes a control portion 31, an operation display portion 32, a communication portion 33, and a storage portion 34.

The control portion 31 provides integrated control over the second information processing apparatus 30. As shown in FIG. 2, the control portion 31 includes a CPU 31A, a ROM 31B, and a RAM 31C. The CPU 31A is a processor that executes various types of calculation processes. The ROM 31B is a nonvolatile storage device storing in advance information including control programs to cause the CPU 31A to execute various types of processes. The RAM 31C is a volatile or nonvolatile storage device used as a temporary memory (work area) for the various types of processes executed by the CPU 31A. The CPU 31A executes the various types of control programs stored in the ROM 31B in advance. Thus, the control portion 31 provides integrated control over the second information processing apparatus 30.

The operation display portion 32 is a user interface of the second information processing apparatus 30. The operation display portion 32 includes a display portion and an operation portion. The display portion includes a liquid crystal display and displays various types of information according to control instructions from the control portion 31. The operation portion includes a keyboard, a mouse, and a touch panel for inputting various types of information to the control portion 31 according to user operations.

The communication portion 33 is a communication interface that executes data communication with external communication equipment such as the printing apparatus 10 and the first information processing apparatus 20 via a wired or wireless connection through the communication network 40.

The storage portion 34 is a nonvolatile storage device, including flash memory, EEPROM, an SSD (solid state drive), and an HDD (hard disk drive).

The storage portion 34 stores application programs such as a word processor used to create and edit document data.

In addition, as shown in FIG. 2, the storage portion 34 stores a printer driver 51 and an email program 52.

The printer driver 51 is a piece of software used to control the printing apparatus 10. The printer driver 51 causes the printing apparatus 10 to execute print jobs.

The email program 52 is a piece of software used to create, send, and receive emails.

Upon receiving an input of an instruction to print data used by an application program while the application program is running, an information processing apparatus known in the art displays a print setting screen used to set conditions for printing the data in a display portion. In addition, a printing system is known to be able to set an output mode of the data to either “print” or “email” on the print setting screen.

Here, when the output mode of the data is set to “email” on the print setting screen, the printing system receives an input of the address of an email to which the data is attached. Accordingly, when the user of the printing system intends to set the destination of the data to a storage such as the mailbox 21 that can store the data, the user needs to set the output mode of the data to “email” and then input the address of the email after issuing the instruction to print the data.

In contrast, the second information processing apparatus 30 according to the embodiment of the present disclosure can save the user time and effort required when the user sets the destination of the data to the storage that can store the data after issuing the instruction to print the data as described below.

Specifically, the storage portion 34 stores in advance a data transmission program 53 (see FIG. 2) that causes the control portion 31 to function as a reception processing portion 61, a setting processing portion 62, and a transmission processing portion 63 shown in FIG. 2. The CPU 31A of the control portion 31 executes the data transmission program 53, thereby functioning as the reception processing portion 61, the setting processing portion 62, and the transmission processing portion 63 shown in FIG. 2.

When the instruction to print the data is input, the reception processing portion 61 receives a selection operation to select a destination of the data from the printing apparatus 10 that can print the data or the mailbox 21 that can store the data. The printing apparatus 10 is an example of a printing apparatus of the present disclosure. In addition, the mailbox 21 is an example of a storage of the present disclosure.

Specifically, the reception processing portion 61 causes the operation display portion 32 to display the selection screen on which the printing apparatus 10 and the mailbox 21 are selectably displayed, and receives the selection operation on the selection screen.

The selection screen includes a selection operation key used for the selection operation and a selected object display portion that is located at a position different from that of the selection operation key and that displays a selected object selected by the selection operation.

The reception processing portion 61 displays a message that the data is to be printed when the printing apparatus 10 is displayed as the selected object in the selected object display portion, and displays a message that the data is to be sent when the mailbox 21 is displayed as the selected object in the selected object display portion.

For example, the storage portion 34 in the second information processing apparatus 30 stores in advance printing apparatus information about the printing apparatus 10. For example, the printing apparatus information includes the name and IP address of the printing apparatus 10. For example, the printing apparatus information is obtained from the printing apparatus 10 and stored in the storage portion 34 when the printer driver 51 is installed. The storage portion 34 may store multiple pieces of printing apparatus information corresponding to multiple printing apparatuses 10.

The storage portion 34 in the second information processing apparatus 30 stores in advance mailbox information about the mailbox 21. For example, the mailbox information includes the name and email address of the user corresponding to the mailbox 21. For example, the mailbox information is input to the second information processing apparatus 30 by a predetermined input operation on the operation display portion 32 and stored in the storage portion 34. The storage portion 34 may store multiple pieces of mailbox information corresponding to multiple mailboxes 21.

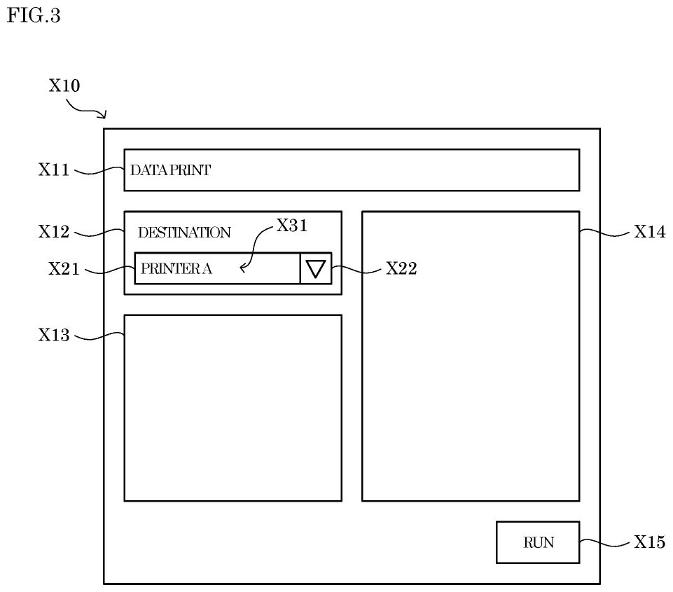

Here, FIG. 3 shows a selection screen X10, which is an example of the selection screen.

The selection screen X10 shown in FIG. 3 includes a message display portion X11, a selected object display portion X12, a printing condition setting portion X13, a preview image display portion X14, and a selection operation key X15.

The message display portion X11 displays messages for the user of the second information processing apparatus 30.

The selection operation key X15 is an example of the selection operation key described above. The selection operation key X15 is used for the selection operation.

The selected object display portion X12 is an example of the selected object display portion described above. The selected object display portion X12 displays the selected object selected by the selection operation at a position different from that of the selection operation key X15 on the selection screen X10.

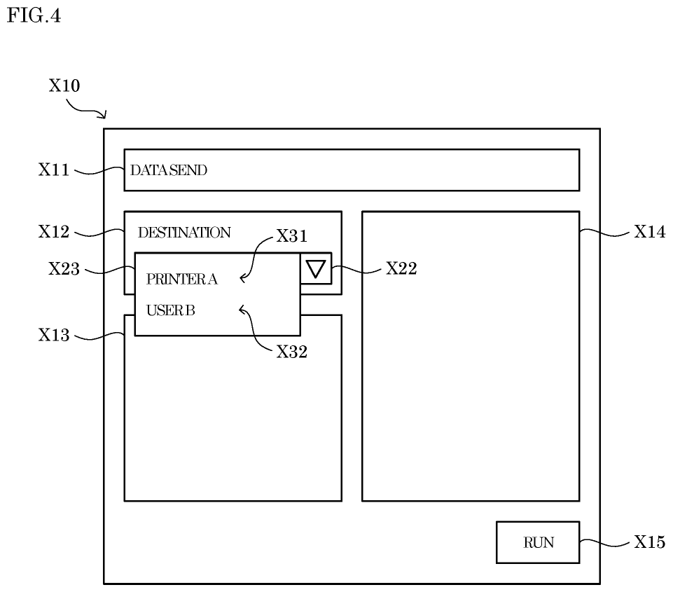

As shown in FIG. 3, the selected object display portion X12 includes a display field X21 and an operation key X22. The display field X21 displays the selected object. The operation key X22 is used to display a first image X31 (see FIG. 4) corresponding to the printing apparatus 10 and a second image X32 (see FIG. 4) corresponding to the mailbox 21.

An operation performed on the operation key X22 on the selection screen X10 results in displaying a drop-down menu X23 shown in FIG. 4. The first image X31 and the second image X32 are selectably displayed in the drop-down menu X23. Specifically, the drop-down menu X23 displays an image indicating the name of the printing apparatus 10 included in the printing apparatus information stored in the storage portion 34 in advance as the first image X31. In addition, the drop-down menu X23 displays an image indicating the name of the user corresponding to the mailbox 21 included in the mailbox information stored in the storage portion 34 in advance as the second image X32.

The reception processing portion 61 causes the operation display portion 32 to display the drop-down menu X23 based on the printing apparatus information and the mailbox information stored in the storage portion 34. FIG. 4 shows a display example of the drop-down menu X23 when the name of the printing apparatus 10 and the name of the user corresponding to the mailbox 21 are “Printer A” and “User B”, respectively.

For example, the user of the second information processing apparatus 30 taps either the first image X31 or the second image X32 displayed in the drop-down menu X23 to switch the selected object displayed in the display field X21.

A tap on either the first image X31 or the second image X32 displayed in the drop-down menu X23 causes the reception processing portion 61 to stop displaying the drop-down menu X23 and to display the image specified by the tap in the display field X21 as the selected object.

Here, when the image specified by the tap is the first image X31, the reception processing portion 61 causes the message display portion X11 to display a message that the data is to be printed (see FIG. 3). When the image specified by the tap is the second image X32, the reception processing portion 61 causes the message display portion X11 to display a message that the data is to be sent (see FIG. 4).

The reception processing portion 61 may change textual information “Run” (see FIG. 3) included in the selection operation key X15 to textual information “Print” when the image specified by the tap is the first image X31, and may change the textual information “Run” (see FIG. 3) included in the selection operation key X15 to textual information “Send” when the image specified by the tap is the second image X32.

The printing condition setting portion X13 is used to set conditions for printing the data. For example, the printing conditions include the number of copies and the print range.

The preview image display portion X14 displays a preview image when the data is to be printed.

The reception processing portion 61 may cause the printing apparatus 10 and the mailbox 21 to be distinguishably displayed on the selection screen. For example, the reception processing portion 61 may display the second image X32 using a color different from that of the first image X31. In addition, the reception processing portion 61 may add a first additional image to the first image X31 and a second additional image, which is different from the first additional image, to the second image X32. For example, the first additional image is an icon representing a printer, and the second additional image is an icon representing a person or a folder.

The reception processing portion 61 may not need to switch the display of the output mode (printing or sending) of the data when the display content in the selected object display portion is switched.

The reception processing portion 61 may receive the selection operation without displaying the selection screen. For example, the reception processing portion 61 may inform the user of the name of the printing apparatus 10 and the name of the user corresponding to the mailbox 21 by voice. In addition, the selection operation may be an input of audio information indicating one of the name of the printing apparatus 10 and the name of the user corresponding to the mailbox 21.

The setting processing portion 62 sets the destination of the data based on the selection operation.

Specifically, the setting processing portion 62 sets the destination of the data based on the display content in the display field X21 when the selection operation key X15 receives an operation. That is, in a case where the first image X31 is displayed in the display field X21 when the selection operation key X15 receives the operation, the setting processing portion 62 sets the destination of the data to the printing apparatus 10. In a case where the second image X32 is displayed in the display field X21 when the selection operation key X15 receives an operation, the setting processing portion 62 sets the destination of the data to the mailbox 21.

It is noted that multiple printing apparatuses 10 may be selectable as the destinations of the data on the selection screen. In this case, the setting processing portion 62 may set multiple printing apparatuses 10 selected as the destinations of the data on the selection screen as the destinations of the data. In addition, multiple mailboxes 21 may be selectable as the destinations of the data on the selection screen. In addition, both the printing apparatus 10 and the mailbox 21 may be selectable as the destinations of the data on the selection screen.

When the setting processing portion 62 sets the destination of the data to the printing apparatus 10, the transmission processing portion 63 executes a first transmission process of sending a print job including the data to the printing apparatus 10.

Specifically, the transmission processing portion 63 starts the printer driver 51. The transmission processing portion 63 instructs the printer driver 51 to create the print job including the data and the printing conditions set on the selection screen X10. The transmission processing portion 63 then instructs the printer driver 51 to send the created print job to the printing apparatus 10. That is, the transmission processing portion 63 causes the printer driver 51 to execute the first transmission process.

When the setting processing portion 62 sets the destination of the data to the mailbox 21, the transmission processing portion 63 executes a second transmission process of sending the data to the mailbox 21 using an email address associated in advance with the mailbox 21. The email address is an example of storage location information of the present disclosure.

Specifically, the transmission processing portion 63 starts the email program 52. The transmission processing portion 63 instructs the email program 52 to create an email to which the data is attached and that includes an email address included in the mailbox information as the destination address. The email may include no subject line and no message body. The transmission processing portion 63 then instructs the email program 52 to send the created email. That is, the transmission processing portion 63 causes the email program 52 to execute the second transmission process.

The mailbox information may include text information constituting the body of the email. In this case, the transmission processing portion 63 may instruct the email program 52 to create an email including the text information included in the mailbox information as the body. In addition, the transmission processing portion 63 may instruct the email program 52 to create an email including the file name of the data as the subject.

### Data Transmission Process

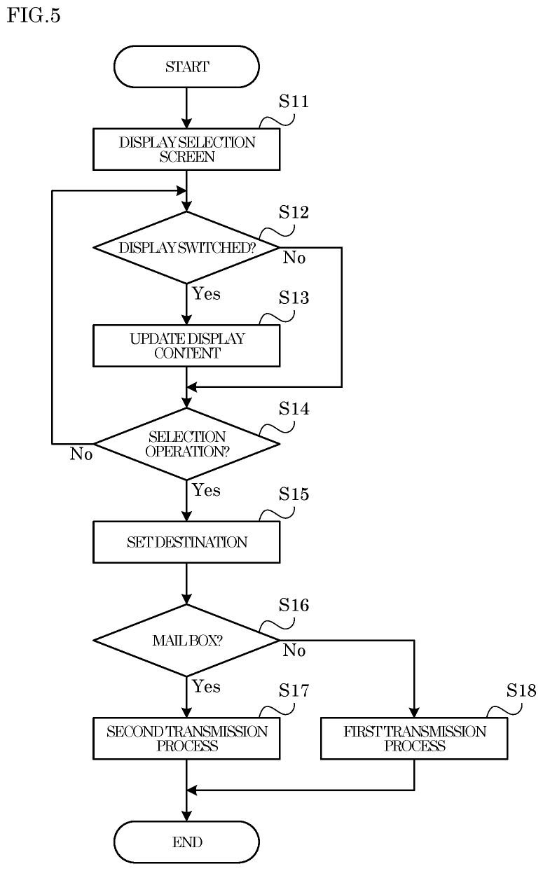

A data transmission method of the present disclosure will now be described with reference to FIG. 5 using an example of a procedure of the data transmission process executed by the control portion 31 of the second information processing apparatus 30. Here, steps S11, S12, . . . represent the numbers of processing procedures (steps) executed by the control portion 31. It is noted that the data transmission process is executed when an instruction to print the data is input while the application program is running.

### Step S11

First, in step S11, the control portion 31 causes the operation display portion 32 to display the selection screen X10 (see FIG. 3). Here, the process in step S11 is an example of a reception step of the present disclosure and is executed by the reception processing portion 61 of the control portion 31.

### Step S12

In step S12, the control portion 31 determines whether the display content in the selected object display portion X12 (see FIG. 3) is switched.

Specifically, when the operation key X22 (see FIG. 3) on the selection screen X10 receives an operation, the control portion 31 displays the drop-down menu X23. If a tap is performed on an image, either the first image X31 or the second image X32 displayed in the drop-down menu X23, different from the image displayed in the display field X21 before the drop-down menu X23 is displayed, the control portion 31 determines that the display content in the selected object display portion X12 is switched.

Upon determining that the display content in the selected object display portion X12 is switched (Yes in step S12), the control portion 31 moves the process to step S13. Upon determining that the display content in the selected object display portion X12 is not switched (No in step S12), the control portion 31 moves the process to step S14.

### Step S13

In step S13, the control portion 31 updates the display content on the selection screen X10 based on the display content in the selected object display portion X12 after the switch.

Specifically, the control portion 31 stops displaying the drop-down menu X23 and displays the image specified by the tap in the display field X21 as the selected object. If the image specified by the tap is the first image X31, the control portion 31 causes the message display portion X11 to display a message that the data is to be printed (see FIG. 3). If the image specified by the tap is the second image X32, the control portion 31 causes the message display portion X11 to display a message that the data is to be sent (see FIG. 4).

### Step S14

In step S14, the control portion 31 determines whether the selection operation is received on the selection screen X10.

Specifically, the control portion 31 determines that the selection operation is received when the selection operation key X15 (see FIG. 3) on the selection screen X10 receives an operation.

Upon determining that the selection operation is received (Yes in step S14), the control portion 31 moves the process to step S15. Upon determining that the selection operation is not received (No in step S14), the control portion 31 moves the process to step S12.

### Step S15

In step S15, the control portion 31 sets the destination of the data based on the selection operation. Here, the process in step S15 is executed by the setting processing portion 62 of the control portion 31.

Specifically, the control portion 31 sets the destination of the data based on the display content in the display field X21 when the selection operation key X15 receives an operation.

### Step S16

In step S16, the control portion 31 determines whether the destination of the data set in step S15 is the mailbox 21.

Upon determining that the destination of the data set in step S15 is the mailbox 21 (Yes in step S16), the control portion 31 moves the process to step S17. Upon determining that the destination of the data set in step S15 is not the mailbox 21 (No step S16), the control portion 31 moves the process to step S18.

### Step S17

In step S17, the control portion 31 executes the second transmission process.

Specifically, the control portion 31 starts the email program 52. The control portion 31 instructs the email program 52 to create an email to which the data is attached and that includes an email address included in the mailbox information as the destination address. The control portion 31 then instructs the email program 52 to send the created email. This stores the email with the data attached thereto in the mailbox 21. Thus, the user that uses the mailbox 21 can receive the email.

### Step S18

In step S18, the control portion 31 executes the first transmission process. Here, the process in steps S17 and S18 is an example of a transmission step of the present disclosure and is executed by the transmission processing portion 63 of the control portion 31.

Specifically, the control portion 31 starts the printer driver 51. The control portion 31 instructs the printer driver 51 to create the print job including the data and the printing conditions set on the selection screen X10. The control portion 31 then instructs the printer driver 51 to send the created print job to the printing apparatus 10. This causes the printing apparatus 10 to execute the print job, thereby causing the data included in the print job to be printed.

In this manner, upon receiving the input of the instruction to print the data, the second information processing apparatus 30 receives the selection operation to select the destination of the data from the printing apparatus 10 or the mailbox 21. When the printing apparatus 10 is selected by the selection operation, the first transmission process of sending the print job including the data to the printing apparatus 10 is executed. When the mailbox 21 is selected by the selection operation, the second transmission process of sending the data to the mailbox 21 using the email address associated in advance with the mailbox 21 is executed. That is, the second information processing apparatus 30 can set both the output mode and the destination of the data with one operation. This can save the user time and effort required when the user sets the destination of the data to a storage that can store the data after issuing the instruction to print the data compared with a configuration that requires an input of the address of an email to which the data is attached when the output mode of the data is set to “email” on the print setting screen.

The first information processing apparatus 20 may be a file server. In this case, the first information processing apparatus 20 may include a shared folder (another example of the storage of the present disclosure) instead of the mailbox 21. In addition, the storage portion 34 of the second information processing apparatus 30 may store in advance shared folder information about the shared folder instead of the mailbox information. For example, the shared folder information includes identification information about the first information processing apparatus, the name of the shared folder, and the path of the shared folder (another example of the storage location information of the present disclosure).

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A data transmission apparatus comprising:
a reception processing portion configured to receive, when an instruction to print data is input, a selection operation to select a destination of the data from a printing apparatus that can print the data or a storage that can store the data; and
a transmission processing portion configured to execute a first transmission process of sending a print job including the data to the printing apparatus when the printing apparatus is selected by the selection operation, and configured to execute a second transmission process of sending the data to the storage using storage location information associated in advance with the storage when the storage is selected by the selection operation.

2. The data transmission apparatus according to claim 1, wherein
the reception processing portion displays a selection screen on which the printing apparatus and the storage are selectably displayed, and receives the selection operation on the selection screen.

3. The data transmission apparatus according to claim 2, wherein
the reception processing portion causes the printing apparatus and the storage to be distinguishably displayed on the selection screen.

4. The data transmission apparatus according to claim 2, wherein
the selection screen includes a selection operation key used for the selection operation and a selected object display portion that is located at a position different from a position of the selection operation key and that displays a selected object selected by the selection operation, and
the reception processing portion displays a message that the data is to be printed when the printing apparatus is displayed as the selected object in the selected object display portion, and displays a message that the data is to be sent when the storage is displayed as the selected object in the selected object display portion.

5. A data transmission method comprising:
a reception step of receiving, when an instruction to print data is input, a selection operation to select a destination of the data from a printing apparatus that can print the data or a storage that can store the data is received; and
a transmission step of executing a first transmission process of sending a print job including the data to the printing apparatus when the printing apparatus is selected by the selection operation, and of executing a second transmission process of sending the data to the storage using storage location information associated in advance with the storage when the storage is selected by the selection operation.
